(19) United States
(12) Patent Application Publication
(10) Pub. No.: US 2006/0080840 A1
(43) Pub. Date: Apr. 20, 2006

(54) Fixed blade knife

(75) Inventor: Jeffrey M. Freeman, Salem, OR (US)

Correspondence Address: FOLEY & LARDNER LLP, 777 EAST WISCONSIN AVENUE, SUITE 3800, MILWAUKEE, WI, 53202-5308, US

(73) Assignee: Fiskars Brands, Inc.

(21) Appl. No.: 10/967,931

(22) Filed: Oct. 19, 2004

(51) Int. Cl. B26B 3/06; F41B 13/02

(52) U.S. Cl. 30/151

(57) ABSTRACT

A fixed blade knife, includes a handle, and a blade, coupled to the handle. The blade has a tang received within the handle. A plurality of lashing points defined by passages extending through both the handle and the tang are provided. The knife may be carried in a sheath with a knife sharpener removably coupled to the sheath.

### FIELD OF THE INVENTION

The present invention relates to a hand held knife having a fixed blade and a corresponding sheath. In particular, the present invention relates to a fixed blade knife system adapted for rugged use.

### BACKGROUND OF THE INVENTION

Fixed blade knives have a sharpened blade that is attached to a handle in any one of a variety of ways known in the art. In order to provide a secure feel and strong design, the blade typically has a tang portion that extends well into the handle. The handle sides are secured to the tang of the blade with screws or other fasteners or with an adhesive.

One challenge associated with fixed blade knives relates to adapting the knives for rugged use. The rigors and strain that a fixed blade knife experiences during rugged use may damage the knife, causing the various components to become dislodged. Also, in some situations it is difficult to lash or couple a knife to a pole for use as a spear, or use the end of the knife handle as a hammer when it would be advantageous to do so. Further, a situation may arise in which the knife handle must be used to break a window, such as to aid a member of an aircrew in escaping from a disabled aircraft. Conventional knife handles may not be suited to such functionality, especially when the window is constructed of break resistant material, such as plexiglasss. Further still, many fixed blade knives are limited in that the knives cannot be safely used to cut live electrical wires.

Fixed blade knifes may also be used in conjunction with sheaths. While sheaths have been provided with sharpeners for sharpening the blade of the knife, the sharpeners typically lose a certain degree of effectiveness with use.

Accordingly, there is a need for a fixed blade knife that provides a stronger connection between the tang and the handle to prevent dislodging of the blade during rugged use. Further, there is a need for a fixed blade knife that can be easily and securely lashed to a pole for use as a spear. Also, there is a need for a fixed blade knife that may be used for hammering, especially hammering to break plexiglass, while minimizing the damage such use causes to the knife. There is also a need for a knife that can be safely used to cut live electrical wires. Further, there is a need for a fixed blade knife system including a sheath with an integral blade sharpener that is configured to address the issue of the loss of effectiveness of the blade sharpener.

It would be desirable to provide a system and/or method that provides one or more of these or other advantageous features. Other features and advantages will be made apparent from the present specification. The teachings disclosed extend to those embodiments that fall within the scope of the appended claims, regardless of whether they accomplish one or more of the aforementioned needs.

### SUMMARY OF THE INVENTION

The invention relates to a knife including a blade that is coupled to a handle. The blade includes a tang that is received within the handle. The knife also includes a plurality of lashing points defined by passages extending through both the handle and the tang.

The invention further relates to a knife system including a knife, a sheath, and a knife sharpener coupled to the sheath. The knife sharpener has a housing and a number of sharpener inserts received within the housing. The sharpener inserts may be easily removed from the housing to be replaced.

The invention further relates to a fixed blade knife with a handle having a body portion and a buttcap. A blade is coupled to the handle, and the handle includes a first recess in the body portion sized to receive a portion of a spear. A second recess in the buttcap is sized to receive a portion of the spear and the second recess is on the same side of the handle as the first recess.

The invention is capable of other embodiments and of being practiced or being carried out in various ways. Alternative exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a perspective view of a fixed blade knife.

FIG. 2 is a sectional view taken generally along line 2-2 of FIG. 1.

FIG. 3 is a cut-away perspective view of a fixed blade knife.

FIG. 4 is a top exploded view of a fixed blade knife.

FIG. 5 is an elevation view of a buttcap for a fixed blade knife.

FIG. 6 is an elevation view of a sheath for a fixed blade knife.

FIG. 7 is a perspective view of a sharpener insert.

### DETAILED DESCRIPTION OF PREFERRED EMBODIMENTS

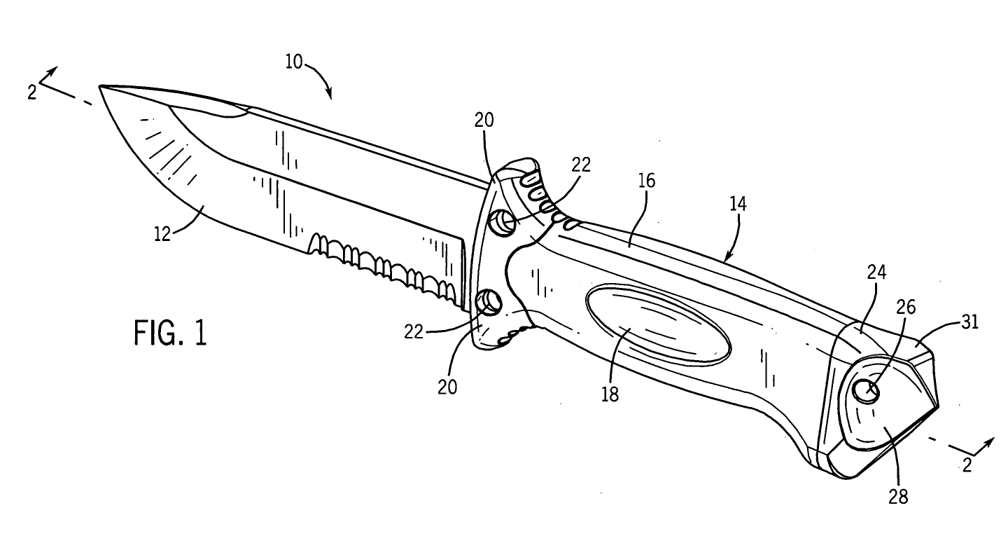

Referring to FIG. 1, according to an exemplary embodiment of the present invention, a knife 10 has a blade 12, and a handle 14. According to an exemplary embodiment, blade 12 may be coated or colored to reduce the visual signature of knife 10. The handle 14 includes an outer surface 16 having a recess 18 on one or both sides of the handle 16. Recess 18 serves to receive and align a pole or other similar object (not shown) when knife 10 is used as a spear. Handle 14 also includes guards 20 for preventing the hand of the operator from moving past handle 14 when the knife 10 is in use.

Further referring to FIG. 1, guards 20 are provided with lashing points, shown as apertures 22 that pass through guards 20 from one side of handle 14 to the opposite side of handle 14. Apertures 22 serve to receive rope, twine, or other bindings that may be used to secure knife 10 to a pole when knife 10 is used as a spear. The use of apertures 22 provides a more secure connection between knife 10 and the pole than simply tying a binding around knife 10 and a pole.

Further referring to FIG. 1, a buttcap 24 is coupled to handle 14. According to an exemplary embodiment, buttcap 24 is made of metal such as stainless steel, but other suitable materials are known in the art. Buttcap 24 is provided with an aperture 26 for receiving a lanyard and securing the lanyard to the knife. Buttcap 24 includes a dished surface 28 that defines a recess to receive a portion of a pole when the knife is used as a spear. The creation of a recess in buttcap 24 also reduces the amount of material needed to construct buttcap 24. Buttcap 24 includes hammering surface 31 for contacting and applying a force to objects when knife 10 is used as a hammer. Buttcap 24 further includes an impact point 33. Impact point 33 provides a small surface area over which the force of a hammering blow may be applied, permitting knife 10 to be used to break window material such as plexiglass. Such a functionality is especially useful for air crewmen who may need to break plexiglass windows to escape a downed helicopter, or for police and fire personnel to gain entry into buildings in an emergency.

In the embodiment depicted in FIG. 1, knife 10 is a fixed blade knife adapted for rugged use. In a typical knife construction, blade 12 is made of metal, such as steel or aluminum, and the handle components may be made of a variety of materials including wood, plastic, metal, or various composites. The term “blade” is not intended to be limiting and may include various types of blades and tools, such as knife blades, saws, skinners, and so forth as is known in the art. Further, the term “handle” is intended to be a generic term referring to all of the components in the handle portion of the knife including various liners, handle sides, bolsters, frames, substrates, buttcaps, receivers, and so forth as is known in the art.

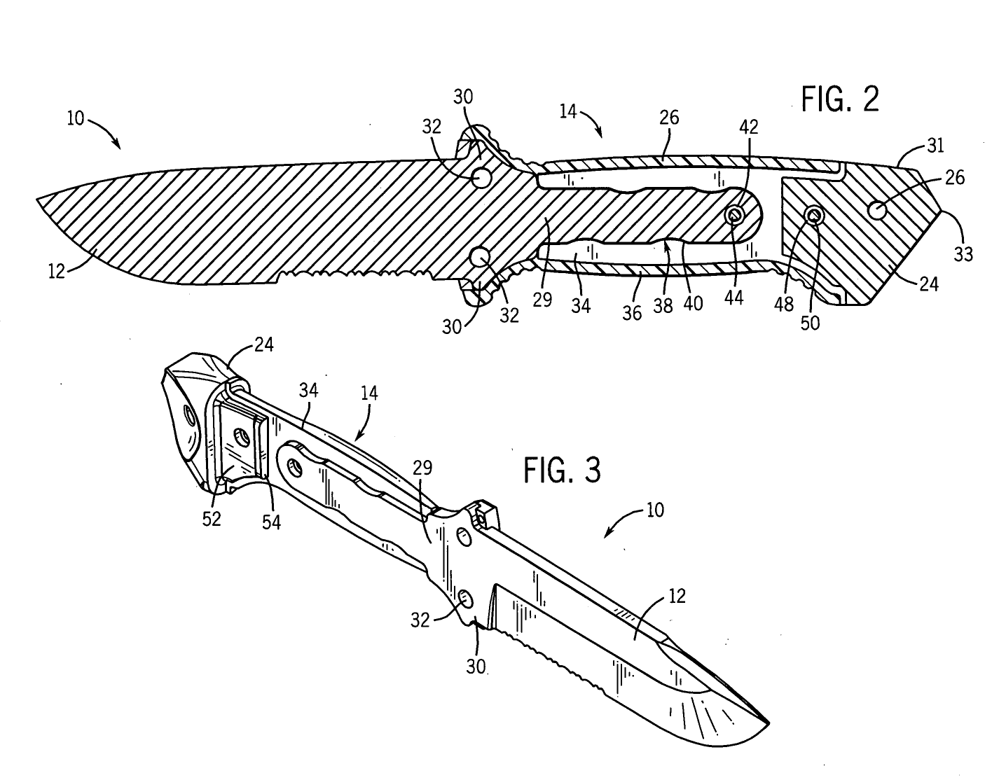

Referring to FIG. 2, blade 12 may be integrally formed with tang 29. Tang 29 includes lateral extensions 30. Extensions 30 are provided with apertures 32 that align with apertures 22 in handle 14.

Further referring to FIG. 2, handle 14 includes a base having a substrate 34. Substrate 34 may be made of a glass filled nylon material. The substrate 34 is covered by overmolding 36. The overmolding 36 may be made of thermoplastic vulcanizate (TPV) or other suitable material. Tang 29 includes contact points such as indentations or negatives 38 that engage corresponding protrusions or positives 40 in substrate 34 and provide for a more secure connection between tang 29 and handle 14. According to an alternative embodiment, the contact points could be positives extending from the tang and used to engage negatives in the substrate 34. Tang 29 is also provided with an aperture 42 that receives a connector that is shown as, but not limited to, stud 44. A metal screw may be used to couple substrate halves 34, with the screw passing through aperture 42 in tang 29. In such an embodiment, substrate material may be used to surround the screw and electrically isolate the screw from tang 29.

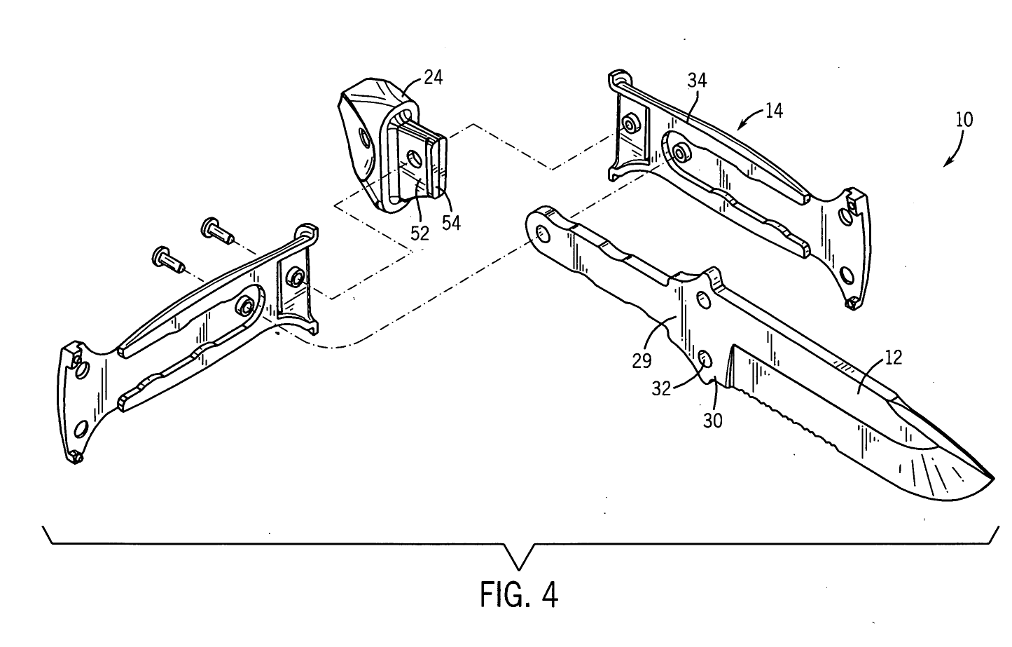

Further referring to FIGS. 2 and 4, substrate 34 physically separates tang 29 from buttcap 24. Substrate 34 serves to absorb the shock created when knife 10 is used as a hammer. Also, substrate 34 electrically isolates tang 29 from buttcap 24 to prevent the corrosion that would be hastened by the presence of an electrochemical potential between the metal tang 29 and the metal buttcap 24. Electrically isolating buttcap 24 from tang 29 also prevents the user's hand from being electrically coupled to the blade via the exposed metal buttcap and thus reduces the possibility of an electric shock to the user if knife 10 is used to sever an electric wire. Buttcap 24 is also provided with an aperture 48 that receives a connector that is shown as, but not limited to, stud 50. In a particularly exemplary embodiment, a metal screw may be used to couple substrate halves 34, with the screw passing through aperture 48 in buttcap 24. In such an embodiment, substrate material may be used to surround the screw and electrically isolate the screw from buttcap 24. FIG.4 does not show the overmolding.

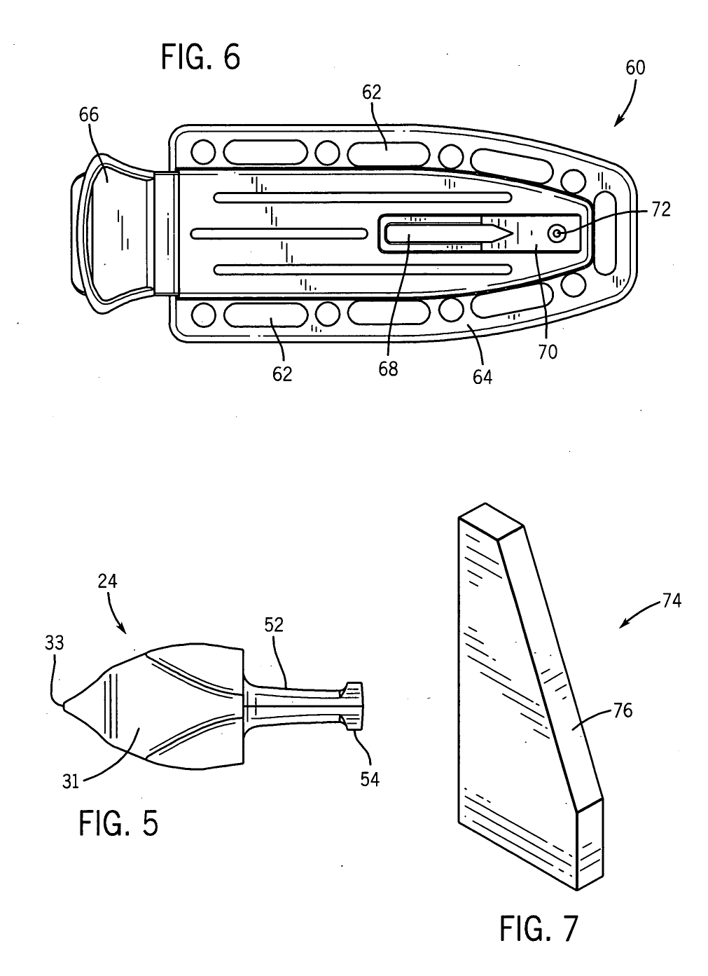

FIG. 3 shows a cutaway view of knife 10 where one substrate half is removed to show the relative positions of buttcap 24, substrate 34, and blade 12. Referring to FIGS. 3 and 5, buttcap 24 includes a protrusion 52. An extension in the form of locking portion 54 extends from protrusion 52 and engages substrate 34 to secure buttcap 24 to handle 14. Locking portion 54 may be a ring of positive material or other suitable device for interlocking with a corresponding recess in the substrate 34.

Referring to FIG. 6, sheath 60 is provided with tie-down points 62 for securing the sheath to an article of clothing or other object (not shown). Alternatively various clips, snaps, loops, and the like could be used as are known in the art. Sheath 60 may be constructed of a glass filled nylon material, covered with an overmolding 64. Overmolding 64 may be made of thermoplastic vulcanizate (TPV) or other suitable material that reduces the sound created by the sheath contacting clothing or other objects. Tab 66 serves to lock knife 10 in sheath 60 by applying a force against handle 14.

Further referring to FIG. 6, sheath 60 is provided with a slot 68 that accommodates blade 12 when sharpening. Insert cap 70 houses sharpener inserts (see FIG. 7) that contact blade 12 when sharpening. Insert cap 70 is removably coupled to sheath 60 by fastener 72. Fastener 72 may be a screw or other such fastener that allows for relatively easy removal of insert cap 70, and therefore creating a knife sharpener having sharpening inserts that are removably coupled to the sheath for ease of replacement. Alternatively, insert cap 70 could be placed in a receiving slot and held in place by friction.

Referring to FIG. 7, sharpener insert 74 has a sharpening plane 76. Sharpener insert 74 may be made of a carbide material or other suitable abrasive material. When used in sheath 60, two inserts 74 are used in conjunction and placed such that the sharpening planes 76 form a “V” for receiving blade 12.

While the detailed drawings and specific examples given herein describe various exemplary embodiments, they serve the purpose of illustration only. It is to be understood that the invention is not limited in its application to the details of construction and the arrangements of components set forth in the preceding description or illustrated in the drawings. For example, the particular lashing points and recesses are but one way of creating a more secure connection between the knife and a pole when the two are used as a spear. Further, removable insert cap that is secured to the sheath by fasteners is shown in one embodiment, but may take other forms that permit the replacement of the sharpener. Furthermore, other substitutions, modifications, changes, and omissions may be made in the design, operating conditions, and arrangements of the exemplary embodiments without departing from the scope of the invention as expressed in the appended claims.

What is claimed is:

1. A knife, comprising:
a handle;
a blade coupled to the handle, the blade having a tang received within the handle; and
a plurality of lashing points defined by passages extending through both the handle and the tang.

2. The knife of claim 1, wherein the handle includes a guard and the tang further includes a plurality of lateral extensions extending into the guard, and wherein the plurality of lashing points extend through both the guard and the extensions.

3. The knife of claim 2, further comprising a buttcap coupled to the handle, wherein the buttcap is physically and electrically isolated from the tang.

4. The knife of claim 3, wherein the tang is provided with a plurality of contact points configured to secure the tang to the handle.

5. The knife of claim 4, wherein the handle further comprises substrate having a second plurality of contact points configured to engage the first plurality of contact points to secure the tang to the handle and an overmolding, the overmolding extending around at least a portion of the two handle halves.

6. The knife of claim 1, wherein the handle includes an outer surface, the outer surface defining a recess configured to receive a pole.

7. A knife system comprising:
a knife;
a sheath; and
a knife sharpener coupled to the sheath, the knife sharpener comprising:
a housing; and
a number of sharpener inserts received within the housing, wherein the sharpener inserts may be easily removed from the housing to be replaced.

8. The system of claim 7, wherein the knife sharpener further comprises an insert cap coupled to the housing by a fastener.

9. The system of claim 8, wherein the knife further comprises:
a handle;
a blade coupled to the handle, the blade having a tang received within the handle; and
a plurality of lashing points defined by passages extending through both the handle and the tang.

10. The system of claim 9, further comprising a buttcap coupled to the handle, wherein the buttcap is physically separated from the tang.

11. The system of claim 10, wherein the buttcap is physically separated from the tang by a non metallic substrate.

12. The system of claim 11, wherein the tang is configured to receive a locking member, the locking member coupled to the handle and the tang.

13. The system of claim 12, wherein the tang is provided with a plurality of contact points configured to secure the tang to the handle.

14. The system of claim 9, wherein the handle includes an outer surface, the outer surface defining a recess configured to receive a pole.

15. The system of claim 14, wherein the handle further comprises two handle halves and an overmolding, the overmolding extending around at least a portion of the two handle halves.

16. A knife, comprising:
a handle having a body portion and a buttcap;
a blade coupled to the handle;
a first recess in the body portion sized to receive a second portion of a spear;
a second recess in the buttcap sized to receive a portion of the spear wherein the second recess is on the same side of the handle as the first recess.

17. The knife of claim 16, further comprising lashing points wherein the tang is provided with a plurality of lateral extensions, the extensions extending into the guard, and wherein the lashing points extend through the guard, and the extensions.

18. The knife of claim 17, wherein the blade includes a tang received within the handle; and the knife further comprises a plurality of lashing points defined by passages extending through both the handle and the tang.

19. The knife of claim 18, wherein the buttcap is physically separated from the tang.

20. The knife of claim 19, wherein the tang is configured to receive a locking member, the locking member coupled to the handle and the tang.

21. The knife of claim 20, wherein the handle further comprises two handle halves and an overmolding, the overmolding extending around at least a portion of the two handle halves.

22. The knife of claim 16, further comprising a buttcap coupled to the handle, wherein the buttcap is physically and electrically isolated from the tang the buttcap including an extension engaging the handle
